(19) United States
(12) Patent Application Publication
(10) Pub. No.: US 2025/0005639 A1
(43) Pub. Date: Jan. 2, 2025

(54) INTELLIGENTLY GENERATING CUSTOMIZED DIGITAL SERVICE SUBSCRIPTIONS

(71) Applicant: International Business Machines Corporation, Armonk, NY (US)

(72) Inventors: Ali Haider, Harrison, NJ (US); Brent Alan Miller, Cary, NC (US); Satisha C. Honnavalli, Bangalore (IN); Gerald Laverte Mitchell, Durham, NC (US); Neil Delima, Scarborough (CA)

(21) Appl. No.: 18/344,109

(22) Filed: Jun. 29, 2023

(51) Int. Cl. G06Q 30/0601; G06Q 30/0201; H04L 67/306

(52) U.S. Cl. CPC G06Q 30/0621; G06Q 30/0201; H04L 67/306

(57) ABSTRACT

In an approach for building a subscription service personalized to a user, a processor monitors a usage of a first subscription service to capture a first set of data regarding a consumption behavior of the user. A processor scans one or more sources to capture a second set of data regarding the user. A processor updates a user profile with the first set of data and the second set of data, wherein the user profile is a first component. A processor captures a third set of data regarding a financial aspect of the first subscription service, wherein the financial aspect is a second component. A processor analyzes the first set of data and the second set of data in relation to the third set of data. A processor optimizes at least one of the first component and the second component to build a second subscription service personalized to the user.

### BACKGROUND OF THE INVENTION

The present invention relates generally to the field of data processing, and more particularly to intelligently generating customized digital service subscriptions.

In recent year, businesses in various industries, such as utility providers and telecommunication providers, built systems of technology and processes to participate in subscription commerce. Subscription commerce has grown in popularity and has spread to other industries, such as entertainment providers, retailers, and prepared meal and delivery services. Subscription commerce encompasses all of the systems of technology and processes to power the sale of a subscription, from sales operations to marketing, to product delivery and deployment, to vendor management, to customer support and lifecycle management. A subscription is an amount of money agreed to be paid on a recurring basis by a consumer to receive a good or service from a business. An example of a subscription may include, but is not limited to, an amount of money agreed to be paid regularly by a customer to receive a newspaper or magazine, to use a phone line or internet service, or to be a member of an organization. Subscription commerce delivers a range of benefits. Businesses get a consistent, recurring revenue stream, which provides an easy way to forecast cash flows and budget, lower administrative costs, and drive higher business valuations. Consumers, on the other hand, get a consistent, recurring cost, which gives them an easy way to better plan and budget for the solutions the consumers need.

### SUMMARY

Aspects of an embodiment of the present invention disclose a method, computer program product, and computer system for building a subscription service personalized to a user. A processor monitors a usage of a first subscription service by a user to capture a first set of data regarding a consumption behavior of the user. A processor scans one or more sources to capture a second set of data regarding the user. A processor updates a user profile of the user with the first set of data and the second set of data, wherein the user profile of the user is a first component of the subscription service. A processor captures a third set of data regarding a financial aspect of the first subscription service, wherein the financial aspect is a second component of the subscription service. A processor analyzes the first set of data and the second set of data in relation to the third set of data. A processor optimizes at least one of the first component and the second component of the subscription service to build a second subscription service personalized to the user. A processor outputs the second subscription service to the user as a recommendation.

In some aspects of an embodiment of the present invention, the first set of data regarding the consumption behavior of the user is defined by one or more attributes, and wherein the one or more attributes include at least one of a categorization of a type of a subscription service, a categorization of a type of content provided by the subscription service, a set of subscription service consumption time stamps, a duration of time during which the subscription service was consumed, a quantity of that which was consumed from the subscription service, a location where the subscription service was consumed, and a type of location where the subscription service was consumed.

In some aspects of an embodiment of the present invention, the second set of data regarding the user includes at least one of a preference of the user and one or more events occurring in a life of the user.

In some aspects of an embodiment of the present invention, the one or more sources includes at least one of a component, a database, the user, and a scan of a social media feed of a social media account of the user and of a set of contacts of the user on a social media network.

In some aspects of an embodiment of the present invention, a processor processes the second set of data using a natural language processing technique. A processor derives a personality trait of the user from the second set of data using a personality analysis method. A processor associates the personality trait of the user with the preference of the user.

In some aspects of an embodiment of the present invention, a processor processes the second set of data using a natural language processing technique. A processor derives the one or more events occurring in a life of the user from the second set of data. A processor associates the one or more events occurring in the life of the user with the consumption behavior of the user.

In some aspects of an embodiment of the present invention, the third set of data regarding the financial aspect of the first subscription service includes at least one of a cost of business associated with a first subscription model, a measure of profitability associated with the first subscription model, and a set of terms from a cost and billing system associated with the first subscription model.

In some aspects of an embodiment of the present invention, subsequent to outputting the second subscription service to the user as the recommendation, a processor enables the user to review the second subscription service. Responsive to the user deciding to subscribe to the second subscription service, a processor enables the user to activate the second subscription service.

In some aspects of an embodiment of the present invention, subsequent to outputting the second subscription service to the user as the recommendation, a processor outputs a request for feedback to the user. A processor gathers the feedback from the user. A processor incorporate the feedback into a reinforcement learning model to improve the second subscription service.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a subscription generation program, on a server within the distributed data processing environment of FIG. 1, in accordance with an embodiment of the present invention; and

FIG. 3 depicts a block diagram of components of a computing environment representing the distributed data processing environment of FIG. 1, in accordance with an embodiment of the present invention.

### DETAILED DESCRIPTION

Embodiments of the present invention recognize that, in recent year, businesses in various industries, such as utility providers and telecommunication providers, built systems of technology and processes to participate in subscription commerce. Subscription commerce has grown in popularity and has spread to other industries, such as entertainment providers, retailers, and prepared meal and delivery services. Subscription commerce encompasses all of the systems of technology and processes to power the sale of a subscription, from sales operations to marketing, to product delivery and deployment, to vendor management, to customer support and lifecycle management. A subscription is an amount of money agreed to be paid on a recurring basis by a consumer to receive a good or service from a business. An example of a subscription may include, but is not limited to, an amount of money agreed to be paid regularly by a customer to receive a newspaper or magazine, to use a phone line or internet service, or to be a member of an organization. Subscription commerce delivers a range of benefits. Businesses get a consistent, recurring revenue stream, which provides an easy way to forecast cash flows and budget, lower administrative costs, and drive higher business valuations. Consumers, on the other hand, get a consistent, recurring cost, which gives them an easy way to better plan and budget for the solutions the consumers need.

Embodiments of the present invention recognize that a challenge businesses with a subscription-based business model face is acquiring new customers to sign up for subscriptions. In prior art, this challenge has been addressed by offering discounts with pre-set term commitments. Despite the discount incentive offered, many customers are still reluctant to commit to a subscription because of inflexible terms or terms that are not aligned with the consumption needs or wants of the customer. Additionally, free trial offers for subscription services only work to an extent because some customers who subscribe for the free trial period will later unsubscribe once the free trial period ends. This can be costly for a business if the cost of acquiring the customer exceeds the price the customer paid for the subscription service. Embodiments of the present invention recognize that another challenge that businesses with a subscription-based business model face is retaining existing customers. Excluding the customers who unsubscribe after the free trial period ends, customers can determine if they are not deriving the desired value commensurate with the subscription cost. When customers determine they are not deriving the desired value because they no longer see a sufficient value proposition, they are likely to unsubscribe. Therefore, embodiments of the present invention recognize a need for a system and method to address the problem of fixed, inflexible subscription service terms and options that results in the challenges noted by intelligently generating a subscription service personalized to the user at the appropriate time.

Embodiments of the present invention provide a system and method to acquire new subscribers and to retain existing subscribers by building a subscription service personalized to a user, based on an identified consumption behavior, a preference of a user, and one or more life events of the user, that complement a retention practice, such as a loyalty program and a trial offer. Embodiments of the present invention build the subscription service by measuring a consumption behavior of the user along certain dimensions of consumption and then, based on learned patterns, generating one or more options for the subscription services that optimizes the input to an optimization function of the personalized subscription service. In addition, embodiments of the present invention adjust the output from the optimization function of the personalized subscription service to achieve an optimized output with a trade-off among other parameters.

Implementation of embodiments of the present invention may take a variety of forms, and exemplary implementation details are discussed subsequently with reference to the Figures.

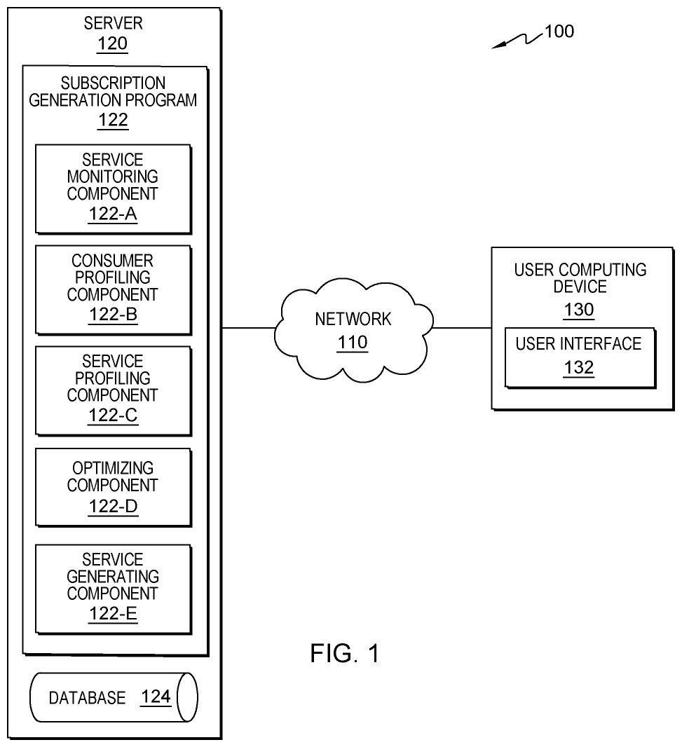

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120 and user computing device 130, and other computing devices (not shown) within distributed data processing environment 100.

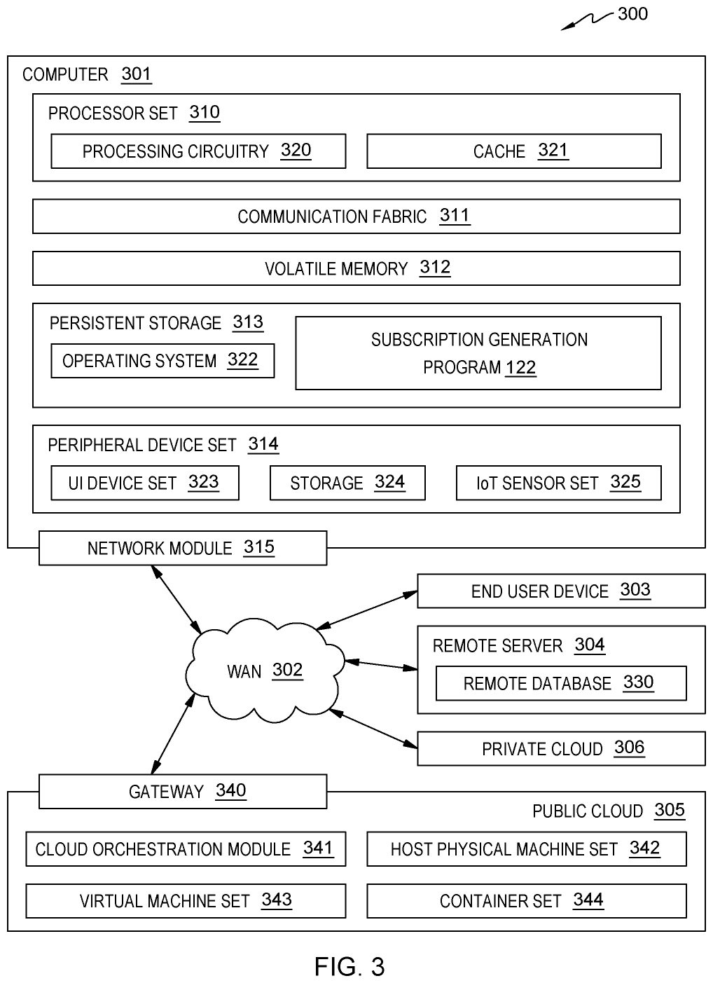

Server 120 operates to run subscription generation program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 3.

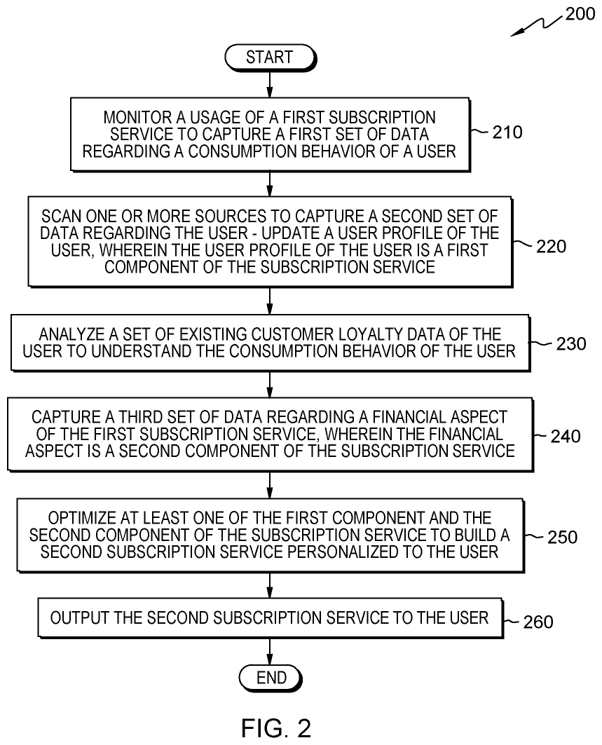

Subscription generation program 122 operates to build a subscription service personalized to a user. In the depicted embodiment, subscription generation program 122 is composed of service monitoring component 122-A, consumer profiling component 122-B, service profiling component 122-C, optimizing component 122-D, and service generating component 122-E. In the depicted embodiment, subscription generation program 122 is a standalone program. In another embodiment, subscription generation program 122 may be integrated into another software product. In the depicted embodiment, subscription generation program 122 resides on server 120. In another embodiment, subscription generation program 122 may reside on another computing device (not shown), provided that subscription generation program 122 has access to network 110. The operational steps of subscription generation program 122 are depicted and described in further detail with respect to FIG. 2.

In an embodiment, the user of user computing device 130 registers with subscription generation program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via subscription generation program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Service monitoring component 122-A operates to monitor a consumption of a subscription service by a user, to capture a set of data related to the consumption of the subscription service by the user (i.e., a consumption behavior), and to determine a rate of frequency of consumption of the subscription service across one or more attributes. In the depicted embodiment, service monitoring component 122-A resides on subscription generation program 122.

Consumer profiling component 122-B operates to manage a profile for the user, wherein the profile managed includes a set of data related to the consumption of the subscription service by the user (i.e., a consumption behavior), a set of data regarding one or more preferences of the user, and a set of data regarding one or more life events of the user. Additionally, consumer profiling component 122-B operates to analyze a set of existing customer loyalty data to understand a consumption behavior of the user with respect to a subscription service model and a set of terms of the subscription service model. In the depicted embodiment, consumer profiling component 122-B resides on subscription generation program 122.

Service profiling component 122-C operates to captures a set of data related to a financial aspect of the subscription service. In the depicted embodiment, service profiling component 122-C resides on subscription generation program 122.

Optimizing component 122-D operates to optimize one or more components of the subscription service to build a subscription service personalized to the user. Optimizing component 122-D of subscription generation program 122 is built using a multi-objective or multi-attribute optimization method known in the art. The inputs to optimizing component 122-D of subscription generation program 122 are captured in steps 210-240. In the depicted embodiment, optimizing component 122-D resides on subscription generation program 122.

Service generating component 122-E operates to build a subscription service personalized to the user by adjusting the inputs to optimizing component 122-D or the outputs from optimizing component 122-D. In the depicted embodiment, service generating component 122-E resides on subscription generation program 122.

Database 124 operates as a repository for data received, used, and/or generated by subscription generation program 122. A database is an organized collection of data. Data includes, but is not limited to, information about user preferences (e.g., general user system settings such as alert notifications for user computing device 130); information about alert notification preferences; a profile created for the user; and any other data received, used, and/or generated by subscription generation program 122.

Database 124 can be implemented with any type of device capable of storing data and configuration files that can be accessed and utilized by server 120, such as a hard disk drive, a database server, or a flash memory. In an embodiment, database 124 is accessed by subscription generation program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that subscription generation program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Subscription generation program 122 enables the authorized and secure processing of personal data and/or confidential company data.

Subscription generation program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Subscription generation program 122 provides information regarding personal and/or confidential company data and the nature (e.g., type, scope, purpose, duration, etc.) of the processing. Subscription generation program 122 provides the user with copies of stored personal and/or confidential company data. Subscription generation program 122 allows the correction or completion of incorrect or incomplete personal and/or confidential company data. Subscription generation program 122 allows for the immediate deletion of personal and/or confidential company data.

User computing device 130 operates to run user interface 132 through which a user can interact with subscription generation program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with subscription generation program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between subscription generation program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from subscription generation program 122 to a user via network 110. User interface 132 can also display or present alerts including information (such as graphics, text, and/or sound) sent from subscription generation program 122 to a user via network 110. In an embodiment, user interface 132 can send and receive data (i.e., to and from subscription generation program 122 via network 110, respectively). Through user interface 132, a user can opt-in to subscription generation program 122; input a set of data regarding the user; create a user profile; input a set of data regarding a preference of the user; set user preferences and alert notification preferences; input a set of data regarding a consumption of a subscription service; input a set of data regarding one or more life events of the user; receive a personalized subscription service; review the personalized subscription service; activate the personalized subscription service; receive a request for feedback; and input feedback.

A user preference is a setting that can be customized for a particular user. A set of default user preferences are assigned to each user of subscription generation program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of subscription generation program 122.

FIG. 2 is a flowchart, generally designated 200, illustrating the operational steps for subscription generation program 122, on server 120 within distributed data processing environment 100 of FIG. 1, in accordance with an embodiment of the present invention. In an embodiment, subscription generation program 122 operates to build a subscription service personalized to a user. It should be appreciated that the process depicted in FIG. 2 illustrates one possible iteration of the process flow, which may be repeated continuously and at a pre-determined interval. A pre-determined interval may be, but is not limited to, daily, weekly, monthly, yearly, upon a change in a consumption of a subscription service by a user, upon a change in a preference of a user, and upon an occurrence of an event in a life of a user.

In step 210, service monitoring component 122-A of subscription generation program 122 monitors a consumption of a subscription service by a user. A user may be, but is not limited to, an existing customer of a subscription service. A subscription service is an arrangement for providing, receiving, or making use of something of a continuing or periodic nature especially on a prepayment plan, such as an application, tool, platform, and/or service made available in-person and/or online (i.e., web-based). A subscription service requires a user profile to be created by a user. A subscription service also requires a user to complete a user profile by entering a set of personal information. The set of personal information may include, but is not limited to, a proper name of the user, a unique profile name that the user may want to be referred to by when using the subscription service, an age of the user, a location of the user (i.e., a home address of the user), a phone number of the user, an e-mail address of the user, a subscription service model the user may have subscribed to on the subscription service, an amount of money the user agreed to pay for the subscription service model, a frequency of times (e.g., by use, daily, weekly, monthly, yearly) the user agreed to pay for the subscription service model, a set of billing details for the subscription service model, a payment method, one or more security and privacy preferences set by the user, and one or more subscription service user preferences set by the user. In an embodiment, service monitoring component 122-A of subscription generation program 122 monitors a consumption of a subscription service by a user subsequent to the user optting-in (i.e., agreeing) to be monitored by service monitoring component 122-A of subscription generation program 122. In an embodiment, service monitoring component 122-A of subscription generation program 122 monitors a consumption of a subscription service by a user over a pre-set period of time. The period of time may include, but is not limited to, a day, a week, a month, a year, and a season. In an embodiment, service monitoring component 122-A of subscription generation program 122 monitors a consumption of a subscription service by a user using a telemetry monitoring technique. The telemetry monitoring technique is a technique that enables continuous tracking of a set of data related to consumption of a subscription service by a user (i.e., a consumption behavior).

In an embodiment, service monitoring component 122-A of subscription generation program 122 captures a first set of data related to the consumption of the subscription service by the user (i.e., a consumption behavior). The consumption of the subscription service by the user is defined by one or more attributes. The one or more attributes may include, but are not limited to, a categorization of a type of subscription service (e.g., a subscription service for watching television shows and movies); a categorization of a type of content provided by a subscription service (e.g., action, anime, comedy, crime, critically acclaimed, documentary, drama, fantasy, horror, independent, international, family, music and musicals, reality, sci-fi, thriller); a set of service consumption time stamps (e.g., a start time corresponding to a time when the user started using the subscription service and an end time corresponding to a time when the user stopped using the subscription service); a duration of time (e.g., seconds, minutes, hours, and/or days) during which the subscription service was consumed; a quantity (i.e., an amount) of that which was consumed from the subscription service; a location (i.e., a particular place) where a subscription service was consumed; and a type of location (e.g., home, work, store, restaurant, gym, park, and/or venue) where a subscription service was consumed. The set of service consumption time stamps may be used to further derive a period of time (e.g., morning, afternoon, and/or evening) when a subscription service is consumed and a frequency of times the subscription service is consumed.

In an embodiment, service monitoring component 122-A of subscription generation program 122 determines a frequency of consumption of the subscription service. In an embodiment, service monitoring component 122-A of subscription generation program 122 determines the frequency of consumption of the subscription service from the set of service consumption time stamps. In an embodiment, service monitoring component 122-A of subscription generation program 122 determines a frequency of consumption of the subscription service across the one or more attributes. For example, service monitoring component 122-A of subscription generation program 122 determines a frequency of consumption of the subscription service across one or more types of content provided by the subscription service, across one or more periods of time during which the subscription service is consumed, across one or more durations of time the subscription service is consumed, across one or more locations at which the subscription service is consumed, and across one or more types of locations at which the subscription service is consumed.

In an embodiment, service monitoring component 122-A of subscription generation program 122 stores the first set of data related to the consumption of the subscription service by the user in a database (e.g., database 124). In an embodiment, service monitoring component 122-A of subscription generation program 122 outputs the first set of data related to the consumption of the subscription service by the user to consumer profiling component 122-B of subscription generation program 122.

In step 220, consumer profiling component 122-B of subscription generation program 122 captures a second set of data. In an embodiment, consumer profiling component 122-B of subscription generation program 122 captures a second set of data regarding the user. The second set of data regarding the user may include, but is not limited to, the first set of data related to the consumption of the subscription service by the user; one or more sets of data regarding one or more preferences of the user; and one or more sets of data regarding one or more life events of the user. The one or more preferences of the user may include, but are not limited to, a topic the user talks about frequently, a type of content provided by a subscription service the user consumes frequently, and a type of location where a subscription service is consumed by the user frequently. The one or more life events of the user may include, but are not limited to, a change in jobs, a move to a different geographical location, and a birth and/or a death of a family member. In an embodiment, consumer profiling component 122-B of subscription generation program 122 captures a second set of data by scanning one or more sources. The one or more sources may include, but are not limited to, a component of subscription generation program 122 (e.g., service monitoring component 122-A), a database (e.g., database 124), a user (i.e., via a user interface (e.g., user interface 132) of a user computing device (e.g., user computing device 130), and a social media feed of a social media account of the user and/or of a set of contacts of the user on a social media network. In an embodiment, consumer profiling component 122-B of subscription generation program 122 captures a second set of data by scanning one or more sources simultaneously (i.e., at the same time). In an embodiment, consumer profiling component 122-B of subscription generation program 122 captures a second set of data by scanning one or more sources periodically (i.e., at a pre-determined interval). In an embodiment, to capture one or more sets of data from a user, consumer profiling component 122-B of subscription generation program 122 enables the user to input a set of data via a user interface (e.g., user interface 132) of a user computing device (e.g., user computing device 130). In an embodiment, to capture one or more sets of data from a social media feed, consumer profiling component 122-B of subscription generation program 122 enables the user to link the user profile created for the user (i.e., for the subscription service) to a social media account of the user on a social media network. Scanning a social media feed of the user and/or a set of contacts of the user on a social media network may contribute a set of information that may have otherwise been overlooked in a building of a learning model. With results from a scan of a social media feed, consumer profiling component 122-B of subscription generation program 122 may better understand a behavior demonstrated by a user when a life event occurs and may generate a more accurate subscription service for the user. Scanning a social media feed of the user and/or a set of contacts of the user on a social media network may also confirm a pattern and/or a preference of usage of the user. For example, consumer profiling component 122-B of subscription generation program 122 may confirm a pattern and/or a preference of usage of the user from active usage of the social media network and from positive reviews and recommendations made to the set of contacts of the user on the social media network.

In an embodiment, consumer profiling component 122-B of subscription generation program 122 processes the second set of data captured. In an embodiment, consumer profiling component 122-B of subscription generation program 122 processes the second set of data captured using a natural language processing technique known in the art. In an embodiment, consumer profiling component 122-B of subscription generation program 122 processes the second set of data captured to derive a set of data regarding the user. In an embodiment, consumer profiling component 122-B of subscription generation program 122 processes the second set of data captured to derive a personality trait of the user using a personality analysis method known in the art. In another embodiment, consumer profiling component 122-B of subscription generation program 122 processes the second set of data captured to derive a personality trait of the user using a clustering machine learning method known in the art. In an embodiment, consumer profiling component 122-B of subscription generation program 122 associates the personality trait of the user derived with the one or more sets of data regarding the one or more preferences of the user. In an embodiment, consumer profiling component 122-B of subscription generation program 122 processes the second set of data captured to derive a set of data regarding the one or more life events of the user. The one or more life events may trigger a change in a consumption behavior. The one or more life events may also trigger a change in a spending habit of the user. The one or more life events may trigger a recommendation for a new subscription service or an existing subscription service that is optimized. In an embodiment, consumer profiling component 122-B of subscription generation program 122 associates the one or more life events of the user derived with a change in a consumption behavior and/or a change in a spending habit of the user. In an embodiment, consumer profiling component 122-B of subscription generation program 122 associates the one or more life events of the user derived with a change in a consumption behavior and/or a change in a spending habit of the user using a machine learning model known in the art.

In an embodiment, consumer profiling component 122-B of subscription generation program 122 adds (i.e., updates) the second set of data regarding the user to the profile created for the user. In an embodiment, consumer profiling component 122-B of subscription generation program 122 outputs the profile created for the user to optimizing component 122-D of subscription generation program 122. The profile created for the user may be considered a first component of the subscription service.

In step 230, consumer profiling component 122-B of subscription generation program 122 analyzes a set of existing customer loyalty data of the user. In an embodiment, consumer profiling component 122-B of subscription generation program 122 analyzes the set of existing customer loyalty data of the user to understand a consumption behavior of the user with respect to the subscription service model the user is currently (i.e., at the present time) subscribed to and a set of billing details for the subscription service model. In an embodiment, consumer profiling component 122-B of subscription generation program 122 adds (i.e., updates) a finding from the analysis to the profile created for the user. In an embodiment, consumer profiling component 122-B of subscription generation program 122 outputs a finding from the analysis to optimizing component 122-D of subscription generation program 122.

In step 240, service profiling component 122-C of subscription generation program 122 captures a third set of data regarding a financial aspect of the subscription service (i.e., information provided by a subscription service provider). The third set of data regarding the financial aspect of the subscription service may include, but is not limited to, a cost of business associated with a particular subscription model; a measure of profitability associated with a particular subscription model; a set of terms from a current (i.e., at the present time) cost and billing system associated with a particular subscription model. In an embodiment, service profiling component 122-C of subscription generation program 122 outputs the third set of data regarding the financial aspect of the subscription service to optimizing component 122-D of subscription generation program 122. The third set of data regarding the financial aspect of the subscription service may be considered a first component of the subscription service.

In step 250, optimizing component 122-D of subscription generation program 122 analyzes the first set of data regarding the consumption of the subscription service by the user and the second set of data regarding the user (i.e., from the profile created for the user) in relation to the third set of data regarding the financial aspect of the subscription service. In an embodiment, optimizing component 122-D of subscription generation program 122 optimizes the subscription service. In an embodiment, optimizing component 122-D of subscription generation program 122 optimizes the subscription service by adjusting a factor of the subscription service. A factor of the subscription service may include, but is not limited to, an input factor and an output factor of the subscription service. An input factor is input into optimizing component 122-D of subscription generation program 122 in steps 210, 220, 230, and 240. An input factor may include, but is not limited to, the first set of data regarding the consumption of the subscription service by the user (e.g., the one or more attributes); the second set of data regarding the set of data regarding the user, the personality trait of the user, the one or more preferences of the user, the one or more life events of the user, the change in the consumption behavior of the user, the change in the spending habit of the user, the set of existing customer loyalty data of the user; and the third set of data regarding the financial aspect of the subscription service (e.g., the cost of business associated with the particular subscription model, the measure of profitability associated with the particular subscription model, and the set of terms from the current (i.e., at the present time) cost and billing system associated with the particular subscription model). An output factor may include, but is not limited to, the measure of profitability associated with the subscription service model to which the user is currently subscribed (i.e., at the present time) and the set of billing details associated with the subscription service model to which the user is currently subscribed (i.e., at the present time).

In an embodiment, optimizing component 122-D of subscription generation program 122 optimizes the subscription service by adjusting the input factor of optimizing component 122-D of subscription generation program 122 to achieve an optimized output (e.g., an optimized cost associated with the subscription service (i.e., paid by the user) and an optimized measure of profitability (i.e., generated for the subscription service provider)). For example, a fitness membership runs on a month-to-month or a year-to-year basis. The fitness membership also offers non-cancelation benefits and upselling for personal trainers and group classes in an effort to increase the revenue stream. Subscription generation program 122 detects a pattern in the usage, uptake, upgrades, and cancellations (i.e., input factors of optimizing component 122-D of subscription generation program 122) to generate a subscription service model optimized for customer retention and consistency (i.e., output factors of optimizing component 122-D of subscription generation program 122). The subscription service model offers either a personal trainer or a group class package as well as a conversion recommendation for weekend, weekly, monthly, or seasonal subscriptions to meet a predictable recurring user revenue stream. That means optimizing component 122-D of subscription generation program 122 generates a subscription service model that meets the user's time-cost-benefit matrix. The subscription service model generated will increase membership retention and will reduce account management and business costs. In another example, a cloud service provider of a managed cloud service notices that a group of pay-as-you-go users frequently use a particular group of managed services to run batch and asynchronous workloads. The batch and asynchronous workloads have lower acceptable response times. Subscription generation program 122 detects the lower acceptable response times and generates a recommendation for the group of pay-as-you-go users to convert to a monthly subscription. The monthly subscription costs less than the pay-as-you go option. The monthly subscription also runs such batch and asynchronous workloads during off-peak hours with less aggressive SLAs. This benefits the users. The provider can then run the batch and asynchronous workloads in data centers with lower operational and power consumption costs, and during times when resources might otherwise sit idle and thus increase costs, as well as generating a more predictable recurring revenue stream. This benefits the cloud provider.

In another embodiment, optimizing component 122-D of subscription generation program 122 optimizes the subscription service by adjusting the output factor (e.g., a current cost vs. a sustainable cost associated with the subscription service and paid by the user) of optimizing component 122-D of subscription generation program 122 to achieve an optimized output. For example, a current cost associated with a subscription service and paid by the user is continually increasing. Optimizing component 122-D of subscription generation program 122 optimizes the subscription service by adjusting the current cost, an output, to a price more sustainable for the user. That means, optimizing component 122-D of subscription generation program 122 adjusts the current cost to a price that may make it more likely the user will continue subscribing to the subscription service than cancelling the subscription service. In another example, optimizing component 122-D of subscription generation program 122 optimizes the subscription service by adjusting an output to make more sustainable choices in the optimization of the design of the subscription service. Optimizing component 122-D of subscription generation program 122 adjusts a time when one or more tasks are completed. Optimizing component 122-D of subscription generation program 122 adjusts the time to a new time during a non-peak hour (i.e., during an optimal usage time for sustainability), an first output, in order to take advantage of lower utility rates, a second output. By adjusting to a new time during a non-peak hour, optimizing component 122-D of subscription generation program 122 optimizes the cost per kWh necessary for processing a task. In an embodiment, optimizing component 122-D of subscription generation program 122 optimizes the subscription service to build a personalized subscription service for the user.

In step 260, service generating component 122-E of subscription generation program 122 builds a personalized subscription service for the user. In another embodiment, service generating component 122-E of subscription generation program 122 enhances an existing subscription service for the user. In an embodiment, service generating component 122-E of subscription generation program 122 outputs the personalized subscription service to the user. In an embodiment, service generating component 122-E of subscription generation program 122 outputs the personalized subscription service to the user via a user interface (e.g., user interface 132) of a user computing device (e.g., user computing device 130). In an embodiment, subscription generation program 122 enables the user to review the personalized subscription service. In an embodiment, subscription generation program 122 enables the user to review the personalized subscription service via a user interface (e.g., user interface 132) of a user computing device (e.g., user computing device 130). In an embodiment, if the user decides to subscribe to the personalized subscription service, subscription generation program 122 enables the user to activate the personalized subscription service via a user interface (e.g., user interface 132) of a user computing device (e.g., user computing device 130).

In an embodiment, subscription generation program 122 outputs a request for feedback to the user. The feedback requested may include, but is not limited to, a positive reaction or a negative reaction to the personalized subscription service proposed. The positive reaction may include, but is not limited to, an acceptance of the personalized subscription service and an indication that the proposal of the personalized subscription service was helpful. The negative reaction may include, but is not limited to, a denial of the personalized subscription service and an indication that the proposal of the personalized subscription service was not helpful. In an embodiment, subscription generation program 122 outputs a request for feedback to the user via a user computing device (e.g., user computing device 130). In another embodiment, subscription generation program 122 gathers feedback from the user without user intervention. In an embodiment, subscription generation program 122 gathers feedback from the user without user intervention by monitoring a consumption behavior of the user after the user subscribes to the personalized subscription service. In an embodiment, subscription generation program 122 enables the user to input feedback via a user interface (e.g., user interface 132) of a user computing device (e.g., user computing device 130). In an embodiment, subscription generation program 122 receives the feedback input by the user. In an embodiment, subscription generation program 122 processes the feedback input by the user. In an embodiment, subscription generation program 122 incorporates the feedback into a reinforcement learning model. In an embodiment, subscription generation program 122 incorporates the feedback into a reinforcement learning model in order to improve a current and/or future personalized subscription service. In an embodiment, subscription generation program 122 incorporates the feedback into a reinforcement learning model to continually adjust one or more factors of the subscription service to continually optimize the subscription service.

FIG. 3 depicts a block diagram of components of server 120 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as subscription generation program 122. In addition to subscription generation program 122, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and subscription generation program 122, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in subscription generation program 122 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in subscription generation program 122 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
monitoring, by one or more processors, a usage of a first subscription service by a user to capture a first set of data regarding a consumption behavior of the user;
scanning, by the one or more processors, one or more sources to capture a second set of data regarding the user;
updating, by the one or more processors, a user profile of the user with the first set of data and the second set of data, wherein the user profile of the user is a first component of the subscription service;
capturing, by the one or more processors, a third set of data regarding a financial aspect of the first subscription service, wherein the financial aspect is a second component of the subscription service;
analyzing, by the one or more processors, the first set of data and the second set of data in relation to the third set of data;
optimizing, by the one or more processors, at least one of the first component and the second component of the subscription service to build a second subscription service personalized to the user; and
outputting, by the one or more processors, the second subscription service to the user as a recommendation.

2. The computer-implemented method of claim 1, wherein the first set of data regarding the consumption behavior of the user is defined by one or more attributes, and wherein the one or more attributes include at least one of a categorization of a type of a subscription service, a categorization of a type of content provided by the subscription service, a set of subscription service consumption time stamps, a duration of time during which the subscription service was consumed, a quantity of that which was consumed from the subscription service, a location where the subscription service was consumed, and a type of location where the subscription service was consumed.

3. The computer-implemented method of claim 1, wherein the second set of data regarding the user includes at least one of a preference of the user and one or more events occurring in a life of the user.

4. The computer-implemented method of claim 1, wherein the one or more sources includes at least one of a component, a database, the user, and a scan of a social media feed of a social media account of the user and of a set of contacts of the user on a social media network.

5. The computer-implemented method of claim 1, wherein scanning the one or more sources to capture the second set of data regarding the user further comprises:
processing, by the one or more processors, the second set of data using a natural language processing technique;
deriving, by the one or more processors, a personality trait of the user from the second set of data using a personality analysis method; and
associating, by the one or more processors, the personality trait of the user with the preference of the user.

6. The computer-implemented method of claim 1, wherein scanning the one or more sources to capture the second set of data regarding the user further comprises:
processing, by the one or more processors, the second set of data using a natural language processing technique;
deriving, by the one or more processors, the one or more events occurring in a life of the user from the second set of data; and
associating, by the one or more processors, the one or more events occurring in the life of the user with the consumption behavior of the user.

7. The computer-implemented method of claim 1, wherein the third set of data regarding the financial aspect of the first subscription service includes at least one of a cost of business associated with a first subscription model, a measure of profitability associated with the first subscription model, and a set of terms from a cost and billing system associated with the first subscription model.

8. The computer-implemented method of claim 1, further comprising:
subsequent to outputting the second subscription service to the user as the recommendation, enabling, by the one or more processors, the user to review the second subscription service; and
responsive to the user deciding to subscribe to the second subscription service, enabling, by the one or more processors, the user to activate the second subscription service.

9. The computer-implemented method of claim 1, further comprising:
subsequent to outputting the second subscription service to the user as the recommendation, outputting, by the one or more processors, a request for feedback to the user;
gathering, by the one or more processors, the feedback from the user; and
incorporating, by the one or more processors, the feedback into a reinforcement learning model to improve the second subscription service.

10. A computer program product comprising:
one or more computer readable storage media and program instructions stored on the one or more computer readable storage media, the program instructions comprising:
program instructions to monitor a usage of a first subscription service by a user to capture a first set of data regarding a consumption behavior of the user;
program instructions to scan one or more sources to capture a second set of data regarding the user;
program instructions to update a user profile of the user with the first set of data and the second set of data, wherein the user profile of the user is a first component of the subscription service;
program instructions to capture a third set of data regarding a financial aspect of the first subscription service, wherein the financial aspect is a second component of the subscription service;
program instructions to analyze the first set of data and the second set of data in relation to the third set of data;
program instructions to optimize at least one of the first component and the second component of the subscription service to build a second subscription service personalized to the user; and
program instructions to output the second subscription service to the user as a recommendation.

11. The computer program product of claim 10, wherein the one or more sources includes at least one of a component, a database, the user, and a scan of a social media feed of a social media account of the user and of a set of contacts of the user on a social media network.

12. The computer program product of claim 10, wherein scanning the one or more sources to capture the second set of data regarding the user further comprises:
program instructions to process the second set of data using a natural language processing technique;
program instructions to derive a personality trait of the user from the second set of data using a personality analysis method; and
program instructions to associate the personality trait of the user with a preference of the user.

13. The computer program product of claim 10, wherein scanning the one or more sources to capture the second set of data regarding the user further comprises:
program instructions to process the second set of data using a natural language processing technique;
program instructions to derive the one or more events occurring in a life of the user from the second set of data; and
program instructions to associate the one or more events occurring in the life of the user with the consumption behavior of the user.

14. The computer program product of claim 10, further comprising:
subsequent to outputting the second subscription service to the user as the recommendation, program instructions to enable the user to review the second subscription service; and
responsive to the user deciding to subscribe to the second subscription service, program instructions to enable the user to activate the second subscription service.

15. The computer program product of claim 10, further comprising:
subsequent to outputting the second subscription service to the user as the recommendation, program instructions to output a request for feedback to the user;
program instructions to gather the feedback from the user; and
program instructions to incorporate the feedback into a reinforcement learning model to improve the second subscription service.

16. A computer system comprising:
one or more computer processors;
one or more computer readable storage media;
program instructions collectively stored on the one or more computer readable storage media for execution by at least one of the one or more computer processors, the stored program instructions comprising:
program instructions to monitor a usage of a first subscription service by a user to capture a first set of data regarding a consumption behavior of the user;
program instructions to scan one or more sources to capture a second set of data regarding the user;
program instructions to update a user profile of the user with the first set of data and the second set of data, wherein the user profile of the user is a first component of the subscription service;
program instructions to capture a third set of data regarding a financial aspect of the first subscription service, wherein the financial aspect is a second component of the subscription service;
program instructions to analyze the first set of data and the second set of data in relation to the third set of data;
program instructions to optimize at least one of the first component and the second component of the subscription service to build a second subscription service personalized to the user; and
program instructions to output the second subscription service to the user as a recommendation.

17. The computer system of claim 16, wherein scanning the one or more sources to capture the second set of data regarding the user further comprises:
program instructions to process the second set of data using a natural language processing technique;
program instructions to derive a personality trait of the user from the second set of data using a personality analysis method; and
program instructions to associate the personality trait of the user with a preference of the user.

18. The computer system of claim 16, wherein scanning the one or more sources to capture the second set of data regarding the user further comprises:
program instructions to process the second set of data using a natural language processing technique;
program instructions to derive the one or more events occurring in a life of the user from the second set of data; and
program instructions to associate the one or more events occurring in the life of the user with the consumption behavior of the user.

19. The computer system of claim 16, further comprising:
subsequent to outputting the second subscription service to the user as the recommendation, program instructions to enable the user to review the second subscription service; and
responsive to the user deciding to subscribe to the second subscription service, program instructions to enable the user to activate the second subscription service.

20. The computer system of claim 16, further comprising:
subsequent to outputting the second subscription service to the user as the recommendation, program instructions to output a request for feedback to the user,
program instructions to gather the feedback from the user; and
program instructions to incorporate the feedback into a reinforcement learning model to improve the second subscription service.
